(19) United States
(12) Patent Application Publication
(10) Pub. No.: US 2011/0018455 A1
(43) Pub. Date: Jan. 27, 2011

(54) DISCHARGE LAMP LIGHTING APPARATUS

(75) Inventor: Kengo Kimura, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/921,812

(22) PCT Filed: Feb. 24, 2009
(86) PCT No.: PCT/JP2009/053249

§ 371 Date: Sep. 10, 2010

(30) Foreign Application Priority Data
Mar. 14, 2008 (JP) 2008-066109

(51) Int. Cl. H05B 41/36

(52) U.S. Cl. 315/226

(57) ABSTRACT

A discharge lamp lighting apparatus includes a resonant circuit (5a to 5d) having a capacitor (C3a to C3d) connected to at least one of primary (P1 to P4) and secondary (S1 to S4) windings of a transformer (T1 to T4), an output of the resonant circuit being connected to a corresponding one of discharge lamps, a triangular wave generator 12 to PWM-control switching elements Qp1 and Qn1that pass a current to the primary winding of the transformer and the capacitor, a lighting monitor unit 8 configured to detect a current passing through at least one predetermined discharge lamp among the discharge lamps and output a detection signal when all of the discharge lamps have lighted, and a PWM comparator to control the switching elements according to the triangular signal and detection signal.

### TECHNICAL FIELD

The present invention relates to a discharge lamp lighting apparatus capable of supplying AC power to a plurality of discharge lamps and stably lighting all of the plurality of discharge lamps.

### BACKGROUND ART

Concerning a discharge lamp lighting apparatus for lighting a discharge lamp such as a cold cathode fluorescent lamp (CCFL), a discharge lamp lighting apparatus employing a technique of monitoring a current passing through the discharge lamp, controlling an oscillation frequency of a resonant circuit, and suppressing excessive stress to be applied to a switching element made of, for example, a MOSFET is disclosed in, for example, Japanese Unexamined Patent Application Publication No. 2007-123010.

The discharge lamp lighting apparatus described in this patent document includes a DC power source 200 and an inverter part 300 having a controllable oscillation frequency. The inverter part 300 receives a DC voltage from the DC power source 200, converts the same into a high-frequency voltage of an own oscillation frequency, and uses the converted high-frequency voltage to operate a discharge lamp load circuit L100 having a series resonant circuit including a resonant capacitor 108 and a resonant inductor 106 and a discharge lamp 107 connected in parallel to the resonant capacitor 108. The discharge lamp lighting apparatus also includes a discharge current monitor part 400 to control a present oscillation frequency of the inverter part 300 when the inverter part 300 is oscillating at a given frequency to convert the DC voltage into a high-frequency voltage.

If the inverter part 300 is oscillating at a start frequency to start the discharge lamp and is converting the DC voltage into a high-frequency voltage and if the discharge current monitor part 400 detects, on monitoring a discharge current, that a discharge current starts to pass from a no-discharge-current-passing state, the discharge current monitor part 400 changes the oscillating start frequency to a lighting frequency to light the discharge lamp 107.

### DISCLOSURE OF INVENTION

In a case where the discharge lamp lighting apparatus described in the patent document lights a plurality of discharge lamps (discharge tubes) through one control circuit, the frequency of a PWM control signal for controlling switching elements 102 and 103 changes from the start frequency to the lighting frequency as soon as one discharge lamp start to light to cause a load current. This results in decreasing a gain of the series resonant circuit and weakening a panel proximity effect. Then, any discharge lamp that is OFF at the moment causes a lighting error.

The present invention provides a discharge lamp lighting apparatus capable of preventing the discharge lamp lighting error.

### Means for Solving the Problem

To solve the problem, a technical aspect of the present invention provides a discharge lamp lighting apparatus for converting DC power into AC power and supplying the AC power to a plurality of discharge lamps. The apparatus includes a resonant circuit having a capacitor connected to at least one of primary and secondary windings of a transformer, an output of the resonant circuit being connected to a corresponding one of the discharge lamps, a plurality of switching elements connected to both ends of a DC power source, to pass a current through the primary winding of the transformer and the capacitor contained in the resonant circuit, a wave generator to generate a triangular signal to PWM-control the plurality of switching elements, a lighting monitor unit to detect a current passing through at least one predetermined discharge lamp among the plurality of discharge lamps and output a detection signal when all of the plurality of discharge lamps have lighted, and a PWM comparator to output, according to the triangular signal from the triangular wave generator and the detection signal, a PWM control signal for controlling the plurality of switching elements.

According to a second aspect of the present invention, the discharge lamp lighting apparatus further includes a comparator to compare the detection signal with a first reference level and a frequency change circuit to change the frequency of the triangular signal to a lower frequency if the detection signal is above the first reference level.

According to a third aspect of the present invention, the lighting monitor of the discharge lamp lighting apparatus includes a current detection circuit to detect currents passing through the plurality of discharge lamps and output the detection signal, a lighting detection circuit to receive the detection signal from the current detection circuit, and when all of the plurality of discharge lamps have lighted, output a lighting completion signal indicating that all of the plurality of discharge lamps have lighted, and a detection signal block circuit to block the detection signal to the PWM comparator until the lighting completion signal is received from the lighting detection circuit.

According to a fourth aspect of the present invention, the discharge lamp lighting apparatus further includes an error amplifier to amplify an error voltage between a voltage of the detection signal and a second reference voltage and receive a burst dimming signal that is a pulse signal for intermittently supplying power to the discharge lamps and a block circuit to block the PWM control signal during an OFF period of the burst dimming signal.

According to a fifth aspect of the present invention, the discharge lamp lighting apparatus further includes a first clamp circuit to clamp an output from the error amplifier during the OFF period of the burst dimming signal so that the output from the error amplifier may not drop below a lower limit value of the triangular signal.

According to a sixth aspect of the present invention, the discharge lamp lighting apparatus further includes a second clamp circuit to make one input terminal voltage of the error amplifier slightly higher than the other input terminal voltage thereof during the OFF period of the burst dimming signal.

### BRIEF DESCRIPTION OF THE DRAWINGS

FIG. 1 is a circuit diagram illustrating a configuration of a discharge lamp lighting apparatus according to a related art.

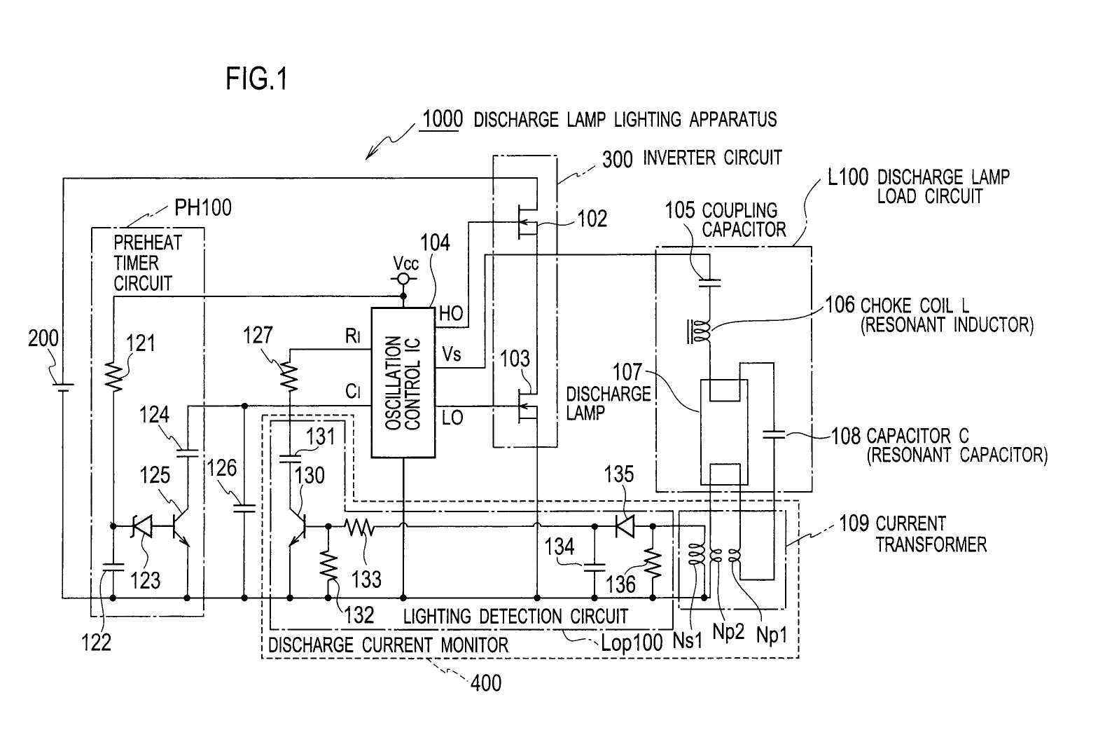

FIG. 2 is a circuit diagram illustrating a configuration of a discharge lamp lighting apparatus according to Embodiment 1 of the present invention.

FIG. 3A is a view illustrating a part of a controller arranged in the discharge lamp lighting apparatus of Embodiment 1.

FIG. 3B is a view illustrating the remaining part of the controller arranged in the discharge lamp lighting apparatus of Embodiment 1.

### BEST MODE OF IMPLEMENTING THE INVENTION

A discharge lamp lighting apparatus according to an embodiment of the present invention will be explained in detail with reference to the drawings. A discharge lamp lighting apparatus according to the present invention detects that all of a plurality of discharge lamps have lighted, and thereafter, changes a drive frequency from a start frequency to a lighting sustain frequency, to prevent a discharge lamp lighting error.

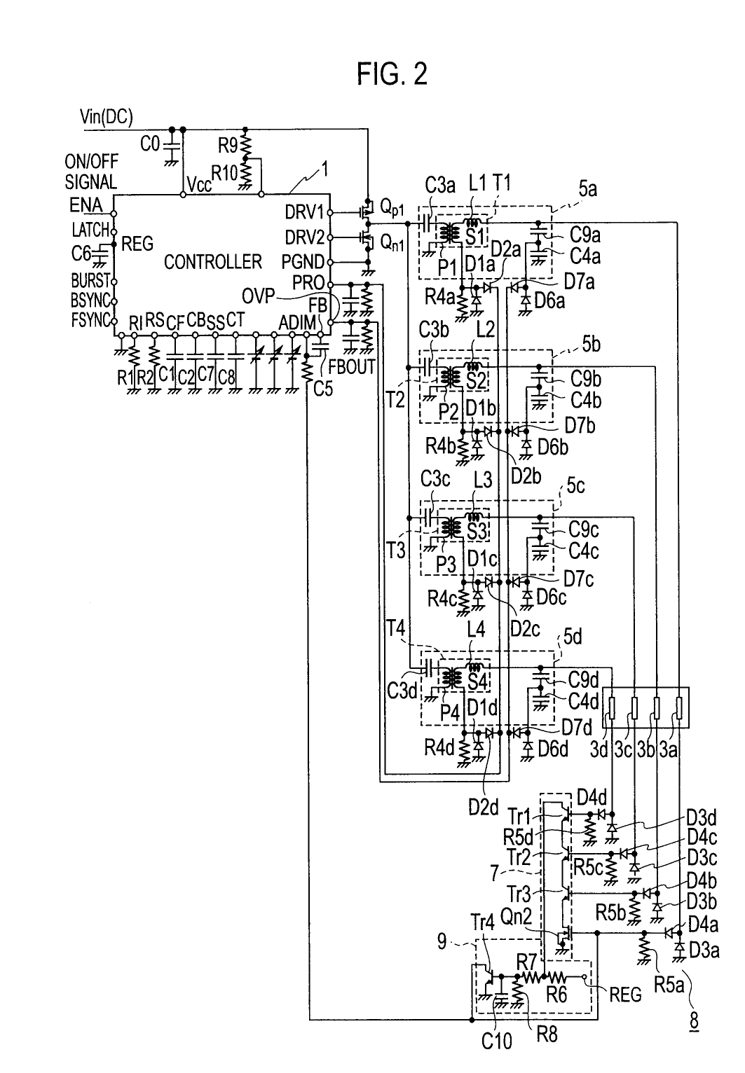

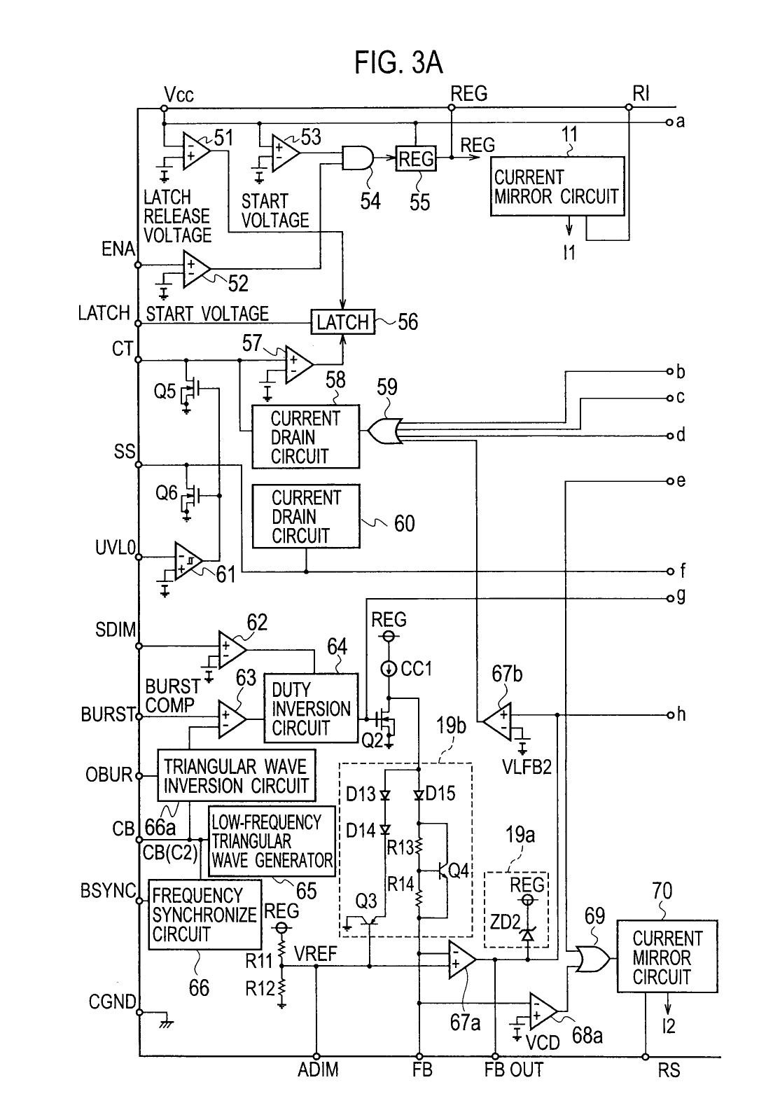

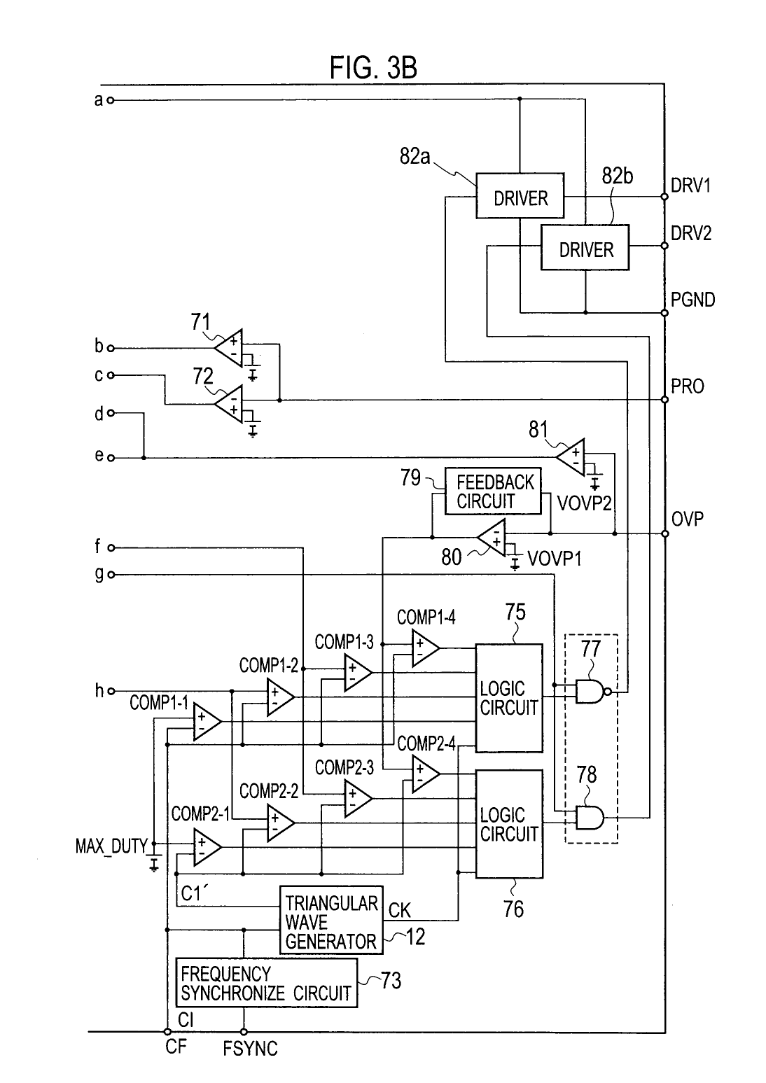

FIG. 2 is a circuit diagram illustrating a configuration of the discharge lamp lighting apparatus according to Embodiment 1 of the present invention. FIG. 3A is a view illustrating a part of a controller of the discharge lamp lighting apparatus of the present embodiment. FIG. 3B is a view illustrating the remaining part of the controller of the discharge lamp lighting apparatus of the embodiment. Reference marks a to h in FIG. 3A correspond to reference marks a to h depicted in FIG. 3B and the same reference marks connect with each other.

In FIG. 2, connected between a DC power source Vin and the ground is a series circuit including a high-side p-type MOSFET Qp1 (referred to as p-type FET Qp1) and a low-side n-type MOSFET Qn1 (referred to as n-type FET Qn1). Connected between a connection point of the p-type FET Qp1 and n-type FET Qn1 and the ground GND are a series circuit of a capacitor C3a and a primary winding P1 of a transformer T1, a series circuit of a capacitor C3b and a primary winding P2 of a transformer T2, a series circuit of a capacitor C3c and a primary winding P3 of a transformer T3, and a series circuit of a capacitor C3d and a primary winding P4 of a transformer T4.

A source of the p-type FET Qp1 is connected to the DC power source Vin and a gate of the p-type FET Qp1 is connected to a terminal DRV1 of the controller 1 that is a semiconductor integrated circuit. A gate of the n-type FET Qn1 is connected to a terminal DRV2 of the controller 1.

Connected between a first end of a secondary winding S1 of the transformer T1 and the ground is a series circuit of capacitors C9a and C4a. A connection point of the capacitors C9a and C4a is connected to a cathode of a diode D6a and an anode of a diode D7a. The diodes D6a and D7a and capacitors C9a and C4a form a rectifying-smoothing circuit to detect a voltage proportional to an output voltage (a voltage applied to a discharge lamp 3a) and output the detected voltage to a terminal OVP of the controller 1.

Connected between a first end of a secondary winding S2 of the transformer T2 and the ground is a series circuit of capacitors C9b and C4b. A connection point of the capacitors C9b and C4b is connected to a cathode of a diode D6b and an anode of a diode D7b. The diodes D6b and D7b and capacitors C9b and C4b form a rectifying-smoothing circuit to detect a voltage proportional to an output voltage and output the detected voltage to the terminal OVP of the controller 1.

Connected between a first end of a secondary winding S3 of the transformer T3 and the ground is a series circuit of capacitors C9c and C4c. A connection point of the capacitors C9c and C4c is connected to a cathode of a diode D6c and an anode of a diode D7c. The diodes D6c and D7c and capacitors C9c and C4c form a rectifying-smoothing circuit to detect a voltage proportional to an output voltage and output the detected voltage to the terminal OVP of the controller 1.

Connected between a first end of a secondary winding S4 of the transformer T4 and the ground is a series circuit of capacitors C9d and C4d. A connection point of the capacitors C9d and C4d is connected to a cathode of a diode D6d and an anode of a diode D7d. The diodes D6d and D7d and capacitors C9d and C4d form a rectifying-smoothing circuit to detect a voltage proportional to an output voltage and output the detected voltage to the terminal OVP of the controller 1.

The first end of the secondary winding S1 of the transformer T1 is connected to a first electrode of the discharge lamp 3a. The first end of the secondary winding S2 of the transformer T2 is connected to a first electrode of a discharge lamp 3b. The first end of the secondary winding S3 of the transformer T3 is connected to a first electrode of a discharge lamp 3c. The first end of the secondary winding S4 of the transformer T4 is connected to a first electrode of a discharge lamp 3d.

L1 is a leakage inductance element of the transformer T1, L2 is a leakage inductance element of the transformer T2, L3 is a leakage inductance element of the transformer T3, and L4 is a leakage inductance element of the transformer T4.

A second electrode of the discharge lamp 3a is connected to a cathode of a diode D3a and an anode of a diode D4a. A second electrode of the discharge lamp 3b is connected to a cathode of a diode D3b and an anode of a diode D4b. A second electrode of the discharge lamp 3c is connected to a cathode of a diode D3c and an anode of a diode D4c. A second electrode of the discharge lamp 3d is connected to a cathode of a diode D3d and an anode of a diode D4d.

A load current detector 8 (the current detector of the present invention) includes the diodes D3a and D4a, a resistor R5a, the diodes D3b and D4b, a resistor R5b, the diodes D3c and D4c, a resistor R5c, the diodes D3d and D4d, and a resistor R5d, detects currents passing through the discharge lamps 3a to 3d, outputs detection voltages proportional to the detected currents to a lighting detection circuit 7 (the lighting detector of the present invention), and supplies a voltage detected by the diodes D3a and D4a and resistor R5a as a detection signal to a terminal FB of the controller 1.

The lighting detection circuit 7 includes a series circuit of npn-type transistors Tr1 to Tr3 and an n-type MOSFET Qn2. When all of the discharge lamps 3a to 3d light, all of the npn-type transistors Tr1 to Tr3 and n-type MOSFET Qn2 turn on according to outputs from the load current detector 8 and output a lighting completion signal indicating that all of the discharge lamps 3a to 3d have lighted, thereby forming a 4-input transistor AND gate.

A cathode of the diode D4d and a first end of the resistor R5d are connected to a base of the npn-type transistor Tr1, a cathode of the diode D4c and a first end of the resistor R5c are connected to a base of the npn-type transistor Tr2, a cathode of the diode D4b and a first end of the resistor R5b are connected to a base of the npn-type transistor Tr3, and a cathode of the diode D4a and a first end of the resistor R5a are connected to a gate of the n-type MOSFET Qn2.

A collector of the npn-type transistor Tr1 is connected through a resistor R6 to a power source REG, an emitter of the npn-type transistor Tr1 is connected to a collector of the npn-transistor Tr2, an emitter of the npn-type transistor Tr2 is connected to a collector of the npn-type transistor Tr3, an emitter of the npn-type transistor Tr3 is connected to a drain of the n-type MOSFET Qn2, and a source of the n-type MOSFET Qn2 is connected to the ground.

A detection signal block circuit 9 has resistors R6, R7, and R8, a capacitor C10, and an npn-type transistor Tr4 and blocks the detection signal from the load current detector 8 to the terminal FB until the lighting completion signal is received from the lighting detection circuit 7. Connected between the power source REG and the ground is a series circuit of the resistors R6, R7, and R8. In parallel to the resistor R8, the capacitor C10 is connected.

A base of the npn-type transistor Tr4 is connected to the parallel circuit of the resistor R8 and capacitor C10, an emitter of the npn-type transistor Tr4 is connected to the ground, and a collector of the npn-type transistor Tr4 is connected to the cathode of the diode D4a, the first end of the resistor R5a, and the terminal FB of the controller 1. A connection point of the resistors R6 and R7 is connected to the collector of the npn-type transistor Tr1.

The controller 1 carries out ON/OFF control of the switching elements Qp1 and Qn1 at a phase difference of about 180° with a PWM control signal having a pulse width based on currents passing through the secondary windings S1 to S4 of the transformers T1 to T4.

Among the discharge lamps 3a to 3d in the discharge lamp lighting apparatus of the embodiment having the above-mentioned configuration, if currents pass through the discharge lamps 3a to 3c and if no current passes through the discharge lamp 3d, no voltage is applied from the load current detector 8 (the diodes D3d and D4d and resistor R5d) to the base of the npn-type transistor Tr1, to turn off the npn-type transistor Tr1.

Namely, if the lighting detection circuit 7 is inoperative, the voltage from the power source REG turns on the npn-type transistor Tr4. As a result, the load current detector 8 (the diodes D3a and D4a and resistor R5a) is connected to the ground, thereby blocking the detection signal from the load current detector 8 (the diodes D3a and D4a and resistor R5a) to the terminal FB.

On the other hand, if currents pass through all of the discharge lamps 3a to 3d, outputs from the load current detector 8 turn on all of the npn-type transistors Tr1 to Tr3 and n-type MOSFET Qn2. Namely, the lighting detection circuit 7 becomes operative to turn off the npn-transistor Tr4, thereby supplying the detection signal from the load current detector 8 (the diodes D3a and D4a and resistor R5a) to the terminal FB.

### Detailed Configuration of Controller

A detailed configuration of the controller 1 will be explained with reference to FIGS. 3A and 3B.

A voltage at a terminal Vcc is supplied to a comparator 53 and a voltage at a terminal ENA is supplied to a comparator 52. If the voltage at the terminal Vcc and the voltage at the terminal ENA become equal to or hither than respective predetermined start voltages, an AND gate provides a high-level output to start an internal regulator 55 to supply a voltage at a terminal REG to each part.

If the voltage at the terminal ENA is equal to or lower than the predetermined start voltage, the AND gate 54 blocks the voltage at the terminal Vcc and the internal regulator 55 nearly zeroes the current consumption of the controller 1 in a standby state.

When the internal regulator 55 starts, each circuit in the controller 1 starts to operate to conduct actions mentioned below.

A triangular wave generator 12 (a wave generator of the present invention) uses a constant current to charge and discharge a capacitor C1 connected to a terminal CF, thereby generating a triangular signal and a clock CK based on an oscillation waveform of the triangular signal. The clock CK has a pulse voltage waveform that is synchronized with the oscillation waveform of the triangular signal at the terminal CF, is at a high level in a rise period and a low level in a fall period, and is sent to PWM comparators COMP1-1 to COMP1-4 and COMP2-1 to COMP2-4 and logic circuits 75 and 76 forming a PWM block circuit.

A comparator 68a (corresponding to the comparator of the present invention) compares a reference voltage VCD with the voltage (detection signal) at the terminal FB and provides a high-level output if the reference voltage VCD is larger than the voltage at the terminal FB and a low-level output if the reference voltage VCD is smaller than the voltage at the terminal FB.

A comparator 81 outputs a high-level signal if a voltage at the terminal OVP is larger than a reference voltage VOVP2 and a low-level output if the voltage at the terminal OVP is smaller than the reference voltage VOVP2. An OR gate 69 operates an OR logic of an output from the comparator 68a and an output from the comparator 81.

In a steady state, a sum current of a current I1 that is optionally set by a current mirror circuit 11 with a constant current value determination resistor R1 connected to a terminal RI and a current I2 that is optionally set by a current mirror circuit 70 with a constant current value determination resistor R2 connected to a terminal RS is used to charge and discharge the oscillator capacitor C1 connected to the terminal CF and generate the triangular signal. This triangular signal has the same rise and fall gradients. The current mirror circuit 11 and current mirror circuit 70 correspond to the frequency change circuit of the present invention.

A current passing through the discharge lamp 3a is converted by the resistor R5a into a voltage, which is supplied to the terminal FB. When a current starts to pass through the discharge lamp 3a, a voltage at the terminal FB increases. When the voltage at the terminal FB becomes equal to or larger than the reference voltage VCD that is set to be lower than a reference voltage VREF (a voltage of the power source voltage REG divided by resistors R11 and R12) of an error amplifier 67a, the comparator 68a provides a low-level output. At this time, if the voltage at the terminal OVP is equal to or lower than the reference voltage VOVP2 of the comparator 81, the OR gate 69 provides a low-level output.

This results in blocking the current 12 from the current mirror circuit 70 and the capacitor C1 is changed and discharged only with the current I1. Namely, in a start time until currents normally passes through the discharge lamps 3a to 3d, voltages are applied to the discharge lamps 3a to 3d at an oscillation frequency (start frequency) higher than a steady oscillation frequency (lighting frequency), to increase the gain of resonant circuits 5a to 5d. The output voltages thus increased and the proximity effect of a panel serving as a load improve the lighting characteristics of the discharge lamps 3a to 3d. In the consequence, the discharge lamps 3a to 3d are simultaneously lighted without a lighting error, i.e., the discharge lamps 3a to 3d are stably started.

The error amplifier 67a (corresponding to the error amplifier of the present invention) amplifies and outputs an error voltage between the voltage from the terminal FB and the reference voltage VREF that is the voltage REG divided by the resistors R11 and R12.

The PWM comparator COMP1-2 compares the error voltage from the error amplifier 67a with the triangular signal from the triangular wave generator 12, and if the error voltage from the error amplifier 67a is equal to or larger than the voltage of the triangular signal from the triangular wave generator 12, provides the logic circuit 75 with a high-level output. If the error voltage from the error amplifier 67a is lower than the voltage of the triangular signal from the triangular wave generator 12, it provides the logic circuit 75 with a low-level output. Namely, the PWM comparator COMP1-2 generates a PWM control signal whose pulse width is based on a current passing through the secondary winding S1. A NAND gate 77 operates NAND logic of the PWM control signal passed through the logic circuit 75 and an output from a duty inversion circuit 64 and outputs the result through a driver 82a to the gate of the switching element Qp1.

The PWM comparator COMP2-2 compares the error voltage from the error amplifier 67a with an inverted signal of the triangular signal from the triangular wave generator 12 inverted around a midpoint between upper and lower limit values and generates a PWM control signal whose pulse width is based on the current passing to the secondary winding S1. The logic circuit 76 sends the PWM control signal from the PWM comparator COMP2-2 through a driver 82b to the gate of the switching element Qn1.

Further, the triangular signal is supplied to a negative terminal (depicted by “−”) of each of the PWM comparators COMP1-1, COMP1-2, COMP1-3, and COMP1-4. The inverted signal C1′ of the triangular signal inverted around the midpoint between the upper and lower limit values is supplied to a negative terminal (depicted by “−”) of each of the PWM comparators COMP2-1, COMP2-2, COMP2-3, and COMP2-4.

Just after a rise of the voltage REG, a soft-start capacitor C7 connected to a terminal SS is charged with a constant current, and therefore, the voltage of the capacitor C7 gradually increases. The voltage of the capacitor C7 at the terminal SS is supplied to a positive terminal (depicted by “+”) of each of the PWM comparators COMP1-3 and COMP2-3. Each of the PWM comparators COMP1-3 and COMP2-3 compares the voltage at the positive terminal with the voltage at the negative terminal and outputs a pulse voltage.

The terminal FB is connected to a negative terminal (depicted by “−”) of the error amplifier 67a and a terminal FBOUT connected to an output of the error amplifier 67a is connected to a positive terminal (depicted by “+”) of each of the PWM comparators COMP1-2 and COMP2-2. Each of the PWM comparators COMP1-2 and COMP2-2 compares the voltage at the positive terminal with the voltage at the negative terminal and outputs a pulse voltage.

The voltage to the terminal OVP is amplified by an amplifier 80 and the amplified voltage is supplied to a positive terminal (depicted by “+”) of each of the PWM comparators COMP1-4 and COMP2-4. Each of the PWM comparators COMP1-4 and COMP2-4 compares the voltage at the positive terminal with the voltage at the negative terminal and outputs a pulse voltage.

The PWM comparators COMP1-1 and COMP2-1 are comparators to determine a maximum ON duty. A positive terminal (depicted by “+”) of each of the comparators receives a maximum duty voltage MAX_DUTY that is set to be slightly lower than the upper limit voltage of the triangular signal and the inverted signal of the triangular signal inverted around the midpoint of the upper and lower limit values of the triangular signal. Each of the comparators compares the voltage at the positive terminal with the voltage at the negative terminal and outputs a pulse voltage.

Between the output pulse voltages from the PWM comparators COMP1-1 and COMP1-2, the logic circuit 75 selects one having a shortest pulse width, and only in a rise period of the triangular signal, sends the selected one through the NAND gate 77 and driver 82a to the terminal DRV1. Among the output pulse voltages from the PWM comparators COMP2-1, COMP2-2, COMP2-3, and COMP2-4, the logic circuit 76 selects one having a shortest pulse width, and only in a rise period of the inverted signal, sends the selected one through the driver 82b to the terminal DRV2.

Through the operation mentioned above, the controller 1 alternately turns on/off the p-type FET Qp1 and n-type FET Qn1, to control currents passing through the discharge lamps 3a to 3d to a predetermined value. If the output of the discharge lamp lighting apparatus is open, the voltage at the terminal OVP increases. If this voltage reaches a reference voltage VOVP1 of the amplifier 80, the amplifier 80 conducts feedback control to control the open output voltage of the discharge lamp lighting apparatus to a predetermined value.

### Burst Dimming Configuration

A burst dimming configuration will be explained. A first clamp circuit 19a has a Zener diode ZD2 connected between the power source REG and the output terminal of the error amplifier 67a. By properly setting a breakdown voltage, the first clamp circuit 19a clamps an output from the error amplifier 67a so that, during an OFF period of burst dimming, the output from the error amplifier 67a (a voltage at the terminal FBOUT) may not decrease below the lower limit value of the triangular signal.

A second clamp circuit 19b has diodes D13, D14, and D15, resistors R13 and R14, and transistors Q3 and Q4 and clamps a voltage at the negative terminal of the error amplifier 67a at a voltage that is based on the voltage at the positive terminal thereof so that, during an OFF period of a burst dimming signal, the voltage at the negative terminal may not be excessively higher than the voltage at the positive terminal.

The PWM signal block circuit has the NAND gate 77 and AND gate 78. The burst dimming signal is supplied through a comparator 63 and duty inversion circuit 64 to the NAND gate 77 and AND gate 78, to block the PWM control signal during an OFF period of burst dimming and turn off the p-type FET Qp1 and n-type FET Qn1. Accordingly, during an OFF period of burst dimming, no power is supplied to the discharge lamps 3a to 3d, no voltage is applied thereto, and no current passes therethrough.

Operation of burst dimming will be explained. First, the current mirror circuit 11 optionally sets the current I1 with the use of the constant current value determination resistor R1 connected to the terminal RI, to charge and discharge a low-frequency oscillation capacitor C2 connected to a terminal CB and generate a low-frequency triangular signal. This low-frequency triangular signal has the same rise and fall gradients.

The burst dimming comparator 63 compares a voltage inverted from the voltage of the capacitor C2 at the terminal CB with a voltage of the burst dimming signal at a terminal BURST. If the voltage at the terminal BURST is lower than the inverted voltage of the capacitor C2 (an OFF period of burst dimming), the comparator 63 provides a low-level output through the duty inversion circuit 64 to a gate of an n-type FET Q2. Since the n-type FET Q2 is OFF, a current passes through a path extending along REG, CC1, D15, Q4, R5a, and the ground.

Namely, the current is drained through the terminal FB, to set a voltage at the negative terminal of the error amplifier 67a to the voltage determined by the second clamp circuit 19b that is slightly higher than the voltage at the positive terminal of the error amplifier 67a. As a result, the error amplifier 67a provides an output that reduces power supplied to the discharge lamps 3a to 3d.

The Zener diode ZD2 of the first clamp circuit 19a clamps the output from the error amplifier 67a so that it may not decrease below the lower limit value of the triangular signal and so that the PWM comparator COMP1-2 may be in a standby state to output a very short PWM control signal. At this time, the logic circuits 75 and 76 block the PWM control signal to turn off the output oscillation.

In this way, if the voltage at the terminal BURST is a pulse signal voltage exceeding the upper and lower limit values of the capacitor C2 or a DC voltage within the range of the upper and lower limit values of the capacitor C2, a pulse-like current is provided through the terminal FB, to intermittently oscillate an output, thereby reducing power supply and achieving burst dimming.

The present invention is not limited to the discharge lamp lighting apparatus of the above-mentioned embodiment. The lighting detection circuit 7 and detection signal block circuit 9 are not limited to the circuits of the embodiment and are achievable in other forms. Although the embodiment employs the triangular wave generator 12, a sawtooth wave generator to generate a sawtooth signal, for example, may be employed.

The control signals for the switching elements Qp1 and Qn1 may have a dead time.

### Effect of Invention

According to the embodiment, the lighting monitor unit detects a current passing through at least one predetermined discharge lamp among a plurality of discharge lamps, and when all of the plurality of discharge lamps have lighted, outputs a detection signal that is usable to prevent a discharge lamp lighting error.

According to the second aspect of the present invention, the frequency change circuit changes the frequency of the triangular signal to a lower frequency if the detection signal is above the first reference level. Namely, at a start time until currents normally pass through the discharge lamps, a voltage is applied to the discharge lamps at an oscillation frequency higher than a steady oscillation frequency. This results in increasing the gain of the resonant circuits and output voltages and improving the lighting characteristics of the discharge lamps.

According to the third aspect of the present invention, the lighting detection circuit receives a detection signal from the current detection circuit, and when all of the plurality of discharge lamps have lighted, outputs a lighting completion signal to indicate that all of the plurality of discharge lamps have lighted. Until the lighting completion signal is provided by the lighting detection circuit, the detection signal block circuit blocks the detection signal to the PWM comparators.

According to the fourth aspect of the present invention, the block circuit blocks a PWM control signal during an OFF period of a burst dimming signal, to turn off the switching elements so that no power is supplied to the discharge lamps during the OFF period of burst dimming.

According to the fifth aspect of the present invention, the first clamp circuit clamps an output of the error amplifier during the OFF period of the burst dimming signal, so that the output of the error amplifier may not decrease below a lower limit value of the triangular signal.

According to the sixth aspect of the present invention, the second clamp circuit sets a voltage at one input terminal of the error amplifier to a voltage slightly higher than a voltage at the other input terminal thereof during the OFF period of the burst dimming signal.

### United States Designation

This application claims benefit of priority under 35USC §119 to Japanese Patent Application No. 2008-066109 filed on Mar. 14, 2008, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

1. Discharge lamp lighting apparatus for converting DC power into AC power and supplying the AC power to a plurality of discharge lamps, comprising:
a resonant circuit having a capacitor connected to at least one of primary and secondary windings of a transformer, an output of the resonant circuit being connected to a corresponding one of the discharge lamps;
a plurality of switching elements connected to both ends of a DC power source, configured to pass a current through the primary winding of the transformer and the capacitor contained in the resonant circuit;
a wave generator configured to generate a triangular signal to PWM-control the plurality of switching elements;
a lighting monitor configured to detect a current passing through at least one predetermined discharge lamp among the plurality of discharge lamps and output a detection signal when all of the plurality of discharge lamps have lighted; and
a PWM comparator configured to output a PWM control signal for controlling the plurality of switching elements according to the triangular signal of the wave generator and the detection signal.

2. The discharge lamp lighting apparatus as set forth in claim 1, comprising:
a comparator comparing the detection signal with a first reference level; and
a frequency change circuit configured to change the frequency of the triangular signal to a lower frequency if the detection signal is above the first reference level.

3. The discharge lamp lighting apparatus as set forth in claim 1, wherein the lighting monitor includes:
a current detector configured to detect currents passing through the plurality of discharge lamps and output the detection signal;
a lighting detector configured to receive the detection signal from the current detector, and
when all of the plurality of discharge lamps have lighted, output a lighting completion signal indicating that all of the plurality of discharge lamps have lighted; and
a detection signal block circuit configured to block the detection signal to the PWM comparator until the lighting completion signal is received from the lighting detector.

4. The discharge lamp lighting apparatus as set forth in claim 1, further comprising:
an error amplifier configured to amplify an error voltage between a voltage of the detection signal and a second reference voltage and receive a burst dimming signal that is a pulse signal for intermittently supplying power to the discharge lamps; and
a block circuit configured to block the PWM control signal during an OFF period of the burst dimming signal.

5. The discharge lamp lighting apparatus as set forth in claim 4, further comprising
a first clamp circuit configured to clamp an output from the error amplifier during the OFF period of the burst dimming signal so that the output from the error amplifier may not drop below a lower limit value of the triangular signal.

6. The discharge lamp lighting apparatus as set forth in claim 5, further comprising
a second clamp circuit configured to make one input terminal voltage of the error amplifier slightly higher than the other input terminal voltage thereof during the OFF period of the burst dimming signal.
